(19) United States
(12) Patent Application Publication
(10) Pub. No.: US 2011/0280699 A1
(43) Pub. Date: Nov. 17, 2011

(54) LIFTING LOADING PLATFORM

(76) Inventors: Martin Zimmermann, Osterholz-Scharmbeck (DE); Thomas Hartel, Hatten (DE)

(21) Appl. No.: 13/063,777

(22) PCT Filed: Sep. 8, 2009
(86) PCT No.: PCT/EP2009/006521

§ 371 Date: May 27, 2011

(30) Foreign Application Priority Data
Sep. 16, 2008 (DE) 10 2008 047 521.1

(51) Int. Cl. B60P 1/44

(52) U.S. Cl. 414/539

(57) ABSTRACT

Tailgates for trucks have a loading platform which can be lifted and lowered and pivoted by a lifting mechanism. The lifting mechanism has hydraulic cylinders for lifting and lowering and pivoting the loading platform. The hydraulic cylinders require a hydraulic subassembly and comparatively thick hydraulic lines in order to operate. The invention provides a tailgate in which the loading platform is raised, lowered and pivoted by electric linear drives (20). The linear drives (20) are provided in a particular manner with a plurality of rod-like electric motors (25) which together drive a gearwheel (32). The gearwheel (32) can rotate a spindle nut (24) on a threaded spindle (23). The threaded spindle (23) can thus be displaced axially like piston rods of hydraulic cylinders. As a result of the electrically operating linear drives (20), the tailgate according to the invention does not need any hydraulic subassembly or any hydraulic hoses.

The invention relates to a tailgate for attaching to a vehicle according to the preamble of claim 1.

Tailgates are used to facilitate the operations of loading in particular heavy articles onto vehicles and unloading them therefrom. Such a tailgate has a loading platform which is articulated preferably on the rear side of a vehicle body such that it can be lifted and lowered and usually also pivoted. The loading platform can be moved by means of a lifting mechanism. Conventional lifting mechanisms have a linear drive, or even two linear drives, for lifting and lowering the loading platform and a linear drive, or even two linear drives, for pivoting the loading platform.

The linear drives of known tailgates are designed as hydraulic cylinders. Although up until now more or less all tailgates have operated with hydraulic cylinders for the purpose of moving loading platforms, this has one significant disadvantage. This resides in the fact that, for the purpose of operating the hydraulic cylinder, a hydraulic subassembly is necessary and hydraulic hoses have to be routed from the hydraulic subassembly to the hydraulic cylinders. A further disadvantage of hydraulic cylinders arises in the case of damage to, in particular leakage in, a hydraulic hose. Oil then escapes, which results in problems ranging from serious contamination to environmental damage.

It is an object of the invention, then, to provide a tailgate which has straightforward, cost-effective and nevertheless reliable linear drives for lifting, lowering and/or pivoting its loading platform.

A tailgate which achieves this object has the features of claim 1. Accordingly, it is provided that at least one linear drive has a plurality of electric motors. Preferably each linear drive has a plurality of electric motors both for lifting and lowering the loading platform and for pivoting the same. Since the respective linear drive has a plurality of electric motors, each electric motor need provide just some of the power which is necessary for actuating the lifting mechanism. Such electric motors may be of comparatively small, in particular narrow, design. The electric motors may thus be accommodated in a space-saving manner in the linear drive, and therefore the linear drive is not much bigger than a hydraulic cylinder.

Each linear drive has a spindle drive, which is assigned all the electric motors of the respective linear drive such that they drive the spindle drive simultaneously. The sum of the driving forces from all the electric motors thus provides the necessary power for driving the respective spindle drive.

The spindle drive preferably has a threaded spindle and a spindle nut corresponding therewith. In the case of such a spindle drive, it is provided that all the electric motors of the linear drive are assigned to the spindle nut. This means that the spindle nut can be driven by all the electric motors simultaneously. If required, it is also nevertheless possible for the spindle nut to be driven just by some electric motors.

In the case of a preferred configuration of the invention, provision is made for the spindle nut to be driven in rotation simultaneously by all, or possibly just some, of the electric motors of the respective spindle drive. By virtue of the spindle nut driven in rotation, the non-rotatable threaded spindle can be retracted and extended like a piston rod of a hydraulic cylinder, and therefore the lifting mechanism can be actuated by the linear drive according to the invention just as well as by hydraulic cylinders, albeit electromechanically rather than hydraulically. This electromechanical drive means that the tailgate does not require any hydraulic subassembly or hydraulic hoses in order to activate the lifting mechanism.

According to a development of the invention, provision is made for the electric motors of each linear drive to be arranged preferably uniformly around the threaded spindle. The electric motors are thus arranged in a space-saving manner in the form of a star around the threaded spindle. Since the individual electric motors need have only a comparatively small amount of power, use can be made of small and, in particular, narrow, in particular rod-like, electric motors which can be arranged in a particularly space-saving manner in the form of a star around the threaded spindle. This makes it possible to form a particularly compact electromechanical spindle drive. Provision is preferably made for the electric motors of each linear drive to be arranged around the threaded spindle such that the longitudinal center axes of all the electric motors of the respective linear drive are located, preferably in a uniformly distributed manner, on a pitch-circle path which runs concentrically in relation to the longitudinal center axis of the threaded spindle. The electric motors are thus distributed in a planetary manner around the threaded spindle.

A preferred configuration of the invention provides that the electric motors have a pinion and the pinions of all the electric motors of the respective linear drive mesh with a common gearwheel, which can drive the spindle nut. The gearwheel, which is driven by the pinions of all the electric motors together, preferably encloses all the pinions of the electric motors arranged in the form of a star around the threaded spindle. By virtue of the pinions in conjunction with the gearwheel, which is assigned to all the pinions together, the power from all the electric motors can be transmitted in a space-saving manner to the spindle nut, with a simultaneous reduction in the rotational speed of the respective electric motor.

It is preferably provided that the gearwheel is formed by a ring with an inner toothing formation in which the pinions of all the electric motors of the respective linear drive engage, wherein the gearwheel encloses the threaded spindle concentrically. In this way, all the electric motors drive the spindle nut of the respective linear drive via a planetary gear mechanism with a comparatively large reduction ratio. By virtue of this large reduction ratio of the planetary gear mechanism, the comparatively small electric motors generate a high level of lifting power for the linear drive, which corresponds to that of common hydraulic cylinders. The pinions of the electric motors here form planet wheels, although these only rotate about their own axes and do not—as is customarily the case with planetary gear mechanisms—also orbit about the threaded spindle.

The linear drive is preferably provided with at least one brake. The brake ensures that, when electric motors are at a standstill, the spindle nut cannot rotate about the threaded spindle and therefore, even when the loading platform is loaded, the length of the spindle drive does not change of its own accord. It is conceivable for each motor to be assigned a dedicated brake. As an alternative, however, provision may also be made for a single brake to be assigned just to the spindle nut. The brakes may be those which take effect automatically when the electric motors are at a standstill, that is to say when they are not driving the spindle nuts in rotation. Particularly suitable brakes here are those which take effect when the supply of power to the electric motors is interrupted and release automatically when the electric motors are supplied with power.

According to the invention, provision is further made for the spindle drive to be designed preferably as roller thread drive. Such a roller thread drive has good efficiency and operates in an essentially play-free manner. The roller thread drive may also be of self-locking design, and therefore under the load on the loading platform, when the electric motors are at a standstill, the spindle nuts cannot be rotated by the threaded spindle and therefore the position of the threaded spindle does not change when the electric motors are at a standstill. In this case, brakes may be dispensed with if appropriate.

The roller thread drive has a spindle nut which has rolling-contact or rolling bodies. The rolling-contact or rolling bodies are provided with a thread which is designed to correspond with the thread of the threaded spindle and meshes with this thread in an essentially play-free manner. In the case of such a spindle drive, it is possible, with a comparatively low level of friction, for the threaded spindle to be moved axially forward and back, by virtue of the spindle nut being rotated, for the purpose of retracting and extending the linear drive.

According to a further preferred configuration of the invention, it is provided that the linear drive has a housing in which, on the one hand, the spindle nut is mounted in a rotatable manner and, on the other hand, the threaded spindle is mounted in an axially displaceable manner. Furthermore, provision is made for all of the electric motors assigned to the respective linear drive to be accommodated in the housing as well. The electric motors are mounted in a non-rotatable manner in the housing, as a result of which the rotatable pinions of the electric motors rotate the spindle nut in the housing. The spindle nut, which can be driven in rotation, rolls on the thread of the threaded spindle, as a result of which the threaded spindle is displaced axially. This displacement takes place along the longitudinal center axis of the housing, the longitudinal center axis of the threaded spindle also being located on this axis. The threaded spindle is thus pushed out of one end of the housing to a greater or lesser extent depending on the direction in which the spindle nut is driven by the electric motors.

A preferred exemplary embodiment of the invention will be explained in more detail hereinbelow with reference to the drawing, in which:

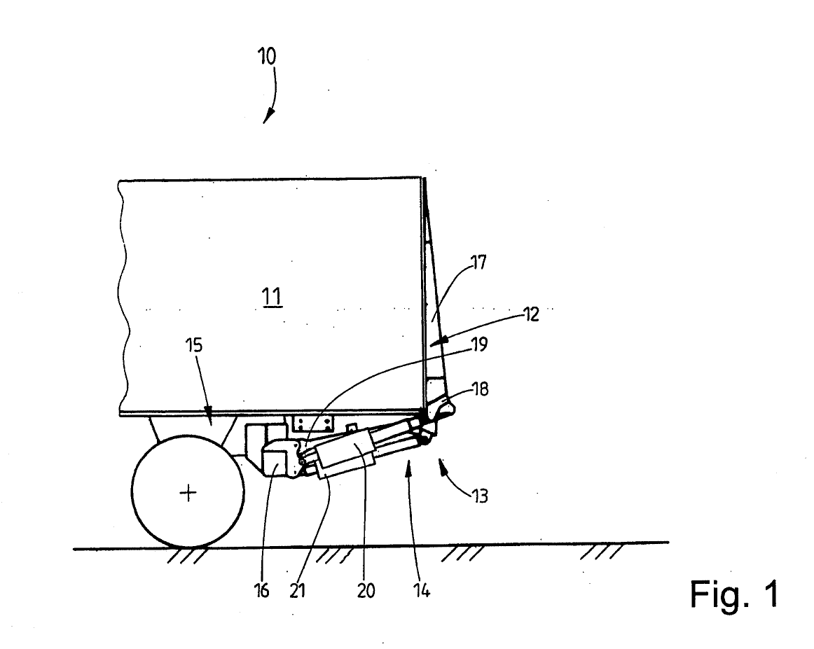

FIG. 1 shows a view of a rear part of a vehicle with a tailgate,

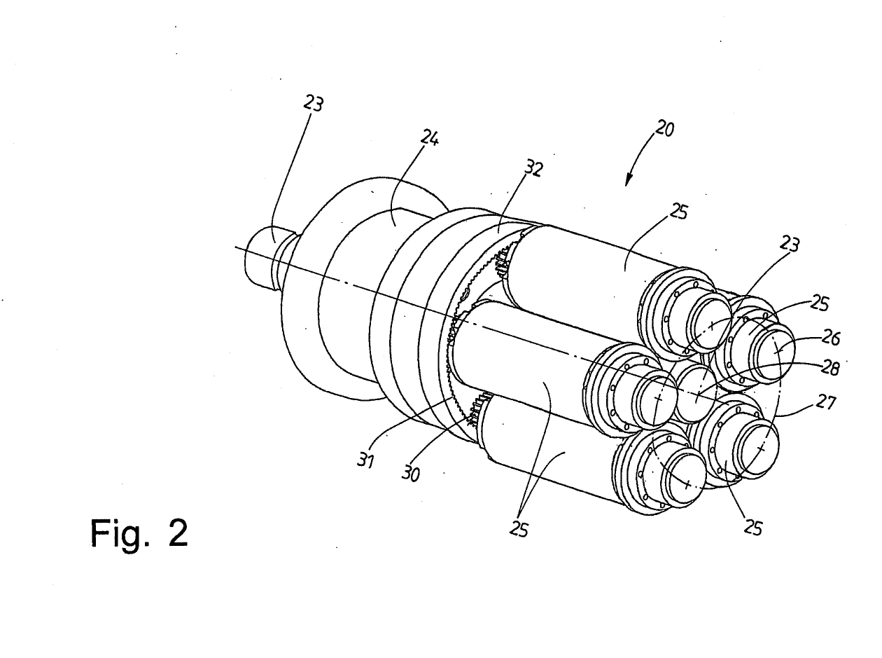

FIG. 2 shows a perspective view of the interior of a linear drive of the tailgate from FIG. 1, and

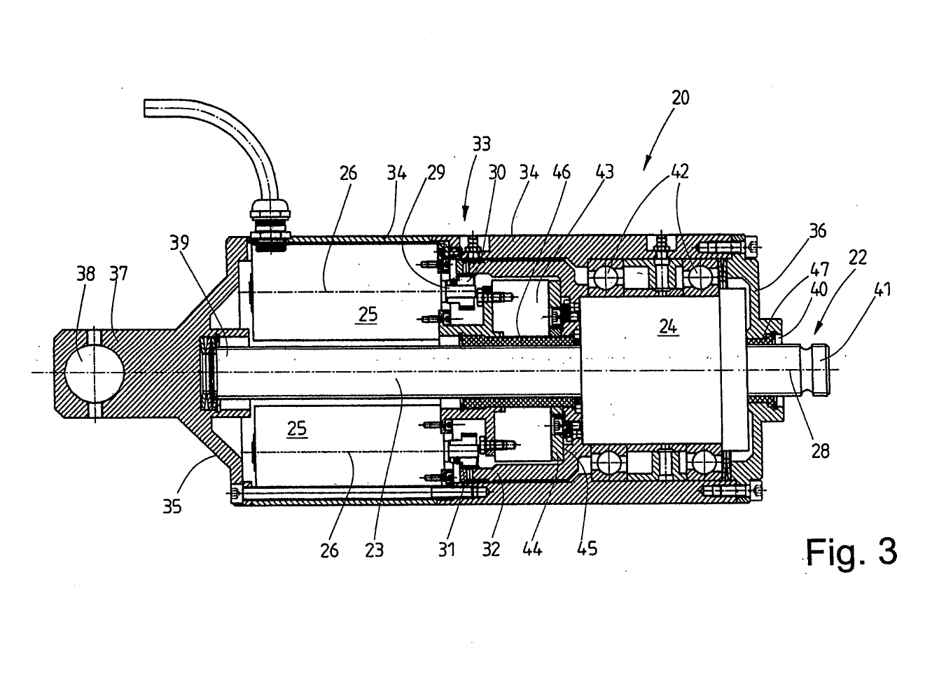

FIG. 3 shows a central longitudinal section through the linear drive.

FIG. 1 shows a rear part of a vehicle, to be precise of a truck 10. The truck 10 has a body 11, which is a so-called box body in the exemplary embodiment shown. The body 11 has an at least partially open or openable rear side 12. This rear side 12 of the truck 10 is assigned a tailgate 13.

The tailgate 13 has a lifting mechanism 14 which is fastened on a vehicle frame 15 (only indicated in the figure) of the truck 10, for example on a transversely directed supporting tube 16. The tailgate 13 also has a loading platform 17. The loading platform 17 is articulated on the lifting mechanism 14 such that it can be pivoted on a lower transverse edge 18 (as seen in the illustration in FIG. 1). The loading platform 17, moreover, can be lowered and raised by the lifting mechanism 14. FIG. 1 shows the closed position of the tailgate 13, in which the loading platform 17 has been moved upward by the lifting mechanism 14 and pivoted into a vertical position behind the body 11 of the truck 10. In this traveling position, the entire loading platform 17 is located behind the body 11 of the truck 10.

The lifting mechanism 14 (only part of which is illustrated in FIG. 1) has two identical link arms 19, which can be pivoted synchronously in parallel, vertical planes. The link arms 19 are articulated on the lower transverse edge 18 of the loading platform 17. The lifting mechanism 14 shown in the figure has, in the region of each of the two link arms 19, a linear drive 20 for pivoting the loading platform 17 and a linear drive 21 for lifting and lowering the loading platform 17. FIG. 1 shows only the linear drives 20 and 21 assigned to the front link arm 19. The other two linear drives 20, 21, which are assigned to a rear link arm, are concealed by the front linear drives 20, 21, and thus cannot be seen, in FIG. 1. Whereas the tailgate 13 shown has two linear drives 20 serving for pivoting the loading platform 17 and two linear drives 21 serving for lifting and lowering the loading platform 17, it is also conceivable for the tailgate 13 to have just a single linear drive 20 for pivoting the loading platform 17 and a single linear drive 21 for lifting and lowering the loading platform 17. All the linear drives 20 and 21 have the same dimensions. It is also conceivable, however, for the linear drive 20 for pivoting the loading platform 17 to be of a different length to the linear drive 21 for lifting and lowering the loading platform 17.

All the linear drives 20 and 21, which are basically all of identical construction, are designed as electromechanical linear drives 20 and 21. The linear drive 20 is illustrated in FIGS. 2 and 3. This linear drive will be described in more detail hereinbelow. The linear drive 21 is designed in the same way. It may also have identical dimensions if appropriate.

The linear drive 20 has a spindle drive 22 with a threaded spindle 23 and a spindle nut 24 and, according to the invention, a plurality of rod-like electric motors 25. All the electric motors 25 are designed preferably identically, to be precise, in particular, as direct-current electric motors which can be supplied with a voltage of usually 24 V, and possibly also 12 V, by the electrical supply system on board the truck 10.

According to FIG. 2, a plurality of identical electric motors 25 are arranged in the form of a star around the central threaded spindle 23 of the spindle drive 22. In the exemplary embodiment shown, five rod-like electric motors are arranged around the threaded spindle 23. Rather than the invention being restricted to this, however, it is possible to provide more or fewer than five electric motors 25. The electric motors 25 are arranged in a uniformly distributed manner around the threaded spindle 23, to be precise such that the longitudinal center axes 26 are located in a uniformly distributed manner on a pitch circle 27, of which the center point is located on a longitudinal center axis 28 of the threaded spindle 23. The elongate electric motors 25, of which the diameter is not much greater than the diameter of the threaded spindle 23, are distributed in a closely packed manner in the form of a star around the threaded spindle 23, and therefore the threaded spindle 23 can still extend through between the electric motors 25 (FIG. 2). The electric motors 25 can all be driven simultaneously. If required, however, it is also conceivable for just some electric motors 25 to be operated.

A drive-shaft stub 29, which projects out of each electric motor 25 on one end side, is provided with a pinion 30. The pinions 30 of all the electric motors 25 mesh in the manner of planet wheels with an inner toothing arrangement 31 of a sleeve-like gearwheel 32. The inner toothing arrangement 31 of the gearwheel 32, as an external gearwheel, encloses all the pinions 30 and this results in a gear mechanism in the manner of a planetary gear mechanism with a relatively large reduction ratio, in particular a reduction ratio of more than 10. The sleeve-like or tube-like gearwheel 32 is connected in a rotationally fixed manner, in particular screwed, to the spindle nut 24 of the spindle drive 22 on one end side. In this way, the spindle nut 24 can be driven in rotation about the longitudinal center axis 28 of the threaded spindle 23 by the gearwheel 32. Instead of use being made of the sleeve-like gearwheel 32 with an inner toothing arrangement 31, it is also possible for the pinions 30 of the electric motors 25 to be arranged around the outside of a gearwheel with an outer toothing arrangement.

The components of the linear drives 20, 21 are arranged in a cylindrical housing 33. In particular all the electric motors 25, the threaded spindle 23 and the spindle nut 24 are located in the housing 33. The housing 33 has a cylindrical housing tube 34 and endpieces 35, 36 on opposite end sides of the housing tube 34. The endpieces 35, 36 close the housing tube 34, preferably in a liquid-tight manner, on the end sides. In the exemplary embodiment shown, for this purpose, the endpieces 35, 36 are screwed to the endsides of the housing tube 34 and sealed by seals (not shown in the figures).

All the electric motors 25 of the linear drive 20 or 21 are arranged or mounted in a fixed, that is say non-rotatable and axially non-displaceable manner in the housing 33.

The endpiece 35, which is located behind the electric motors 25, is provided with a fastening protrusion 37 having a transversely directed through-bore 38. The linear drive 20 or 21 is thereby connected in an articulated manner to a fixed part of the vehicle frame 15, in particular the supporting tube 16. The opposite endpiece 36 of the housing 33 has a central opening, through which a free end 41 of the threaded spindle 23 extends.

By virtue of the spindle nut 24 being rotated, the threaded spindle 23—depending on the direction of rotation—can be retracted into the housing 33 and extended out of the same. For this purpose, the threaded spindle 23, which is coupled in a non-rotatable manner to the loading platform 17, is guided in an essentially play-free manner, such that it can be moved axially in the housing 33, on opposite sides of the spindle nut 24, to be precise in bearings 46, 47. If appropriate, it may also be sufficient for the threaded spindle 23 to be mounted just in the spindle nut 24. FIG. 3 shows the fully retracted threaded spindle 23. The spindle nut 24 is mounted in a rotatable, but axially non-displaceable, manner in the housing tube 34 by means of bearings 42. The action of the spindle nut 24 being rotated on the non-rotatable threaded spindle 23 by the gearwheel 32 results in the threaded spindle 23 being correspondingly retracted into the housing 33 of the linear drive 20 or 21 or in the threaded spindle 23 being extended out of the housing 33. When the threaded spindle 23 is fully retracted into the housing 33 (FIG. 3), its end 39 is supported in the endpiece 35 of the housing 33.

In the simplest case, the spindle nut 24, which is only shown in outline in the figures, has an internal thread which corresponds with the external thread on the threaded spindle 23. This may be a fine-pitch thread with one or more starts or turns.

The spindle drive 22 is preferably provided with a spindle nut 24 having a plurality of rolling-contact or roller bodies. The rolling-contact or roller bodies have on the outside, at least in part, a thread which corresponds with the external thread of the thread spindle 23, that is to say one which meshes therewith. A spindle nut 24 designed in this way serves for the smooth conversion of the rotary movement of the spindle nut 24 into an axial movement of the threaded spindle 23.

As an alternative, it is also conceivable for the spindle drive 22 to be designed as a recirculating roller or ball drive, in particular a roller thread drive.

The spindle drive 22 may be of self-locking design. It is also conceivable, however, to have a spindle drive 22 without self locking.

The linear drive 20 or 21 also has a brake 43. In the exemplary embodiment shown, the brake 43 is designed such that it blocks the rotatability of the tube-like or cup-like gearwheel 32 for driving the spindle nut 24. For this purpose, the brake 43 has a brake disk 44 which can be moved axially along the longitudinal center axis 28 of the threaded spindle 23 and pushes against an annular surface 45 of the hollow, cup-like gearwheel 32 when the brake is active, that is to say it curbs the rotatability of the spindle nut 24. The brake 43 is preferably active when the electric motors 25 are at a standstill, that is say are not supplied with power. The brake disk 44 is then pressed against the annular surface 45 of the hollow gearwheel 32 mechanically by at least one spring or magnetically by at least one permanent magnet. The brake 43 is deactivated electrically during operation of the electric motors 25 by virtue of the brake disk 44 being moved or lifted away from the annular surface 45 of the gearwheel 32, for example, by an electromagnet.

As an alternative, it is also conceivable for at least one electric motor 25, or else all the electric motors 25, to be assigned a dedicated brake. It is then possible to dispense with the brake 43 between the electric motors 25 and the spindle nut 24.

All the electric motors 25 of the relevant linear drive 20, 21 are usually driven simultaneously, to be precise at the same rotational speed. However, it is also conceivable, in particular for lowering the loading platform 18 or also for pivoting the same downward, less power being required for this purpose, to drive just a single electric motor 25 or some of the electric motors 25 of each linear drive 20, 21. It is possible here for the driven electric motors 25 selected to be operated at a higher rotational speed. It is also conceivable, in the case of relatively low lifting speeds or pivoting speeds of the loading platform 17, to drive just one electric motor 25 or just some (selected) electric motors 25 of the respective linear drive 20, 21 at a lower rotational speed.

List of designations

| | |
|---|---|
| 10 | Truck |
| 11 | Body |
| 12 | Rear side |
| 13 | Tailgate |
| 14 | Lifting mechanism |
| 15 | Vehicle frame |
| 16 | Supporting tube |
| 17 | Loading platform |
| 18 | Transverse edge |
| 19 | Link arm |
| 20 | Linear drive |
| | (pivoting) |
| 21 | Linear drive |
| | (lifting/lowering) |
| 22 | Spindle drive |
| 23 | Threaded spindle |
| 24 | Spindle nut |
| 25 | Electric motor |
| 26 | Longitudinal center axis |
| 27 | Pitch circle |
| 28 | Longitudinal center axis |
| 29 | Drive-shaft stub |
| 30 | Pinion |
| 31 | Inner toothing arrangement |
| 32 | Gearwheel |
| 33 | Housing |
| 34 | Housing tube |
| 35 | Endpiece |
| 36 | Endpiece |
| 37 | Fastening protrusion |
| 38 | Through-bore |
| 39 | End |
| 40 | Opening |
| 41 | Free end |
| 42 | Bearing |
| 43 | Brake |
| 44 | Brake disk |
| 45 | Annular surface |
| 46 | Bearing |
| 47 | Bearing |

1. A tailgate for attaching to a vehicle, comprising:
a loading platform (17); and
a lifting mechanism (14) which has at least one linear drive (20, 21) for lifting and lowering and/or pivoting the loading platform (17),
wherein the at least one linear drive (20, 21) has a plurality of electric motors (25).

2. The tailgate as claimed in claim 1, wherein all the electric motors (25) of the respective linear drive (20, 21) are assigned a spindle drive (22), such that each of the electric motors (25) drive the respective spindle drive (22) simultaneously.

3. The tailgate as claimed in claim 2, wherein the respective spindle drive (22) has a threaded spindle (23) and a spindle nut (24) corresponding therewith, wherein the electric motors (25) of the linear drive (20, 21) drive the spindle nut (33) simultaneously.

4. The tailgate as claimed in claim 3, wherein the spindle nut (24) of each the linear drive (20, 21) is driven in rotation by all the electric motors (25) of the relevant linear drive (20, 21) together.

5. The tailgate as claimed in claim 3, wherein the electric motors (25) are arranged uniformly around the threaded spindle (23).

6. The tailgate as claimed in claim 3, characterized in that longitudinal center axes (26) of all the electric motors (25) of the respective linear drive (20, 21) are arranged, in a uniformly distributed manner, on a pitch circle (27) which runs concentrically in relation to the longitudinal center axis (28) of the threaded spindle (23).

7. The tailgate as claimed in claim 3, wherein the electric motors (25) drive the spindle nut (24) of the respective linear drive (20, 21) via a gear mechanism.

8. The tailgate as claimed in claim 3, wherein each of the electric motors (25) has a pinion (30), and the pinions (30) of all the electric motors (25) of the respective linear drive (20, 21) mesh with a common gearwheel (32), wherein the gearwheel (32) drives the respective spindle nut (24) in rotation, and is connected to the spindle nut (24).

9. The tailgate as claimed in claim 3, wherein the spindle nut (24) and/or each of the electric motors (25) are/is assigned a brake (43).

10. The tailgate as claimed in claim 2, wherein the spindle drive (22) is a roller thread drive.

11. The tailgate as claimed in claim 3, wherein the spindle nut (24) has rolling-contact and/or rolling bodies which are provided with a thread which corresponds with a thread of the threaded spindle (23) and meshes with the thread of the threaded spindle (23).

12. The tailgate as claimed in claim 3, wherein the linear drive (20, 21) has a housing (33) in which the spindle nut (24) is mounted, on the one hand, in a rotatable manner and, on the other hand, in an axially essentially non-displaceable manner.

13. The tailgate as claimed in claim 12, wherein the electric motors (25) are mounted at a fixed location, in a non-rotatable manner, in the housing (33) of the linear drive (20, 21).

14. The tailgate as claimed in claim 7, wherein the gear mechanism is a planetary gear mechanism.

15. The tailgate as claimed in claim 9, wherein the brake is a magnetic brake.
